(19) United States
(12) Patent Application Publication
(10) Pub. No.: US 2022/0085447 A1
(43) Pub. Date: Mar. 17, 2022

(54) BATTERY MODULE AND BATTERY PACK INCLUDING THE SAME

(71) Applicants: HYUNDAI MOTOR COMPANY, Seoul (KR); KIA CORPORATION, Seoul (KR)

(72) Inventors: Jong Wook LEE, Hwaseong-si (KR); Yun Ho KIM, Suwon-si (KR); In Gook SON, Hwaseong-si (KR); Yeon Man JEONG, Yongin-si (KR); Tae Hyuck KIM, Asan-si (KR)

(73) Assignees: HYUNDAI MOTOR COMPANY, Seoul (KR); KIA CORPORATION, Seoul (KR)

(21) Appl. No.: 17/388,834

(22) Filed: Jul. 29, 2021

(30) Foreign Application Priority Data
Sep. 15, 2020 (KR) 10-2020-0118578

(51) Int. Cl. H01M 50/209; H01M 10/48; H01M 50/105; H01M 50/507; H01M 50/59

(52) U.S. Cl. CPC H01M 50/209; H01M 10/482; H01M 50/59; H01M 50/105; H01M 50/507; H01M 10/486

(57) ABSTRACT

A battery module and a battery pack including the same are disclosed. The battery module includes a plurality of battery cells, which are stacked in a first direction, and a pair of end plates, which are in contact with two ends of the stacked structure, in which the plurality of battery cells are stacked, in the first direction, wherein at least one end plate is spaced apart from the stacked structure by a predetermined distance to define a fitting space into which a temperature sensor is fitted.

### CROSS-REFERENCE TO RELATED APPLICATION

This application claims the priority to and the benefit of Korean Patent Application No. 10-2020-0118578, filed on Sep. 15, 2020, the disclosure of which is incorporated herein by reference.

### TECHNICAL FIELD

The present disclosure relates to a battery module and a battery pack including the same.

### BACKGROUND

In recent years, in response to the global trend toward reduction of carbon dioxide emissions, demand is rapidly increasing for an electrical vehicle, which creates power by driving a motor using electrical energy charged in an energy storage device such as a battery, in place of a typical internal combustion engine vehicle, which creates power through combustion of fossil fuel.

The performance of an electrical vehicle mainly depends on the capacity and performance of an energy storage device such as a battery for storing electrical energy to be supplied to a drive motor.

A vehicular battery, which is adapted to store electrical energy to be supplied to a motor for creating power required for travel of a vehicle, must have not only excellent electrical characteristics such as excellent discharging and charging performance and a long service life but also excellent mechanical characteristics such as high durability under adverse conditions of high temperature and severe vibration.

Furthermore, from the automobile manufacturer's point of view, it is advantageous for battery hardware to be manufactured in a modular form, which has a standardized size or capacity so as to be applicable to various kinds of vehicles.

Details described as the background art are intended merely for the purpose of promoting understanding of the background of the present disclosure, and should not be construed as an acknowledgment of the prior art that is previously known to those of ordinary skill in the art.

### SUMMARY

Therefore, the present disclosure provides a battery module, which has a standardized size or capacity so as to be applied to various kinds of vehicles, and a battery pack including the battery module.

In one form of the present disclosure, the above and other objects can be accomplished by the provision of a battery module including a plurality of battery cells, which are stacked one on another in a first direction, and a pair of end plates, which are respectively in surface contact with two ends of the stacked structure, in which the plurality of battery cells are stacked, in the first direction, wherein at least one of the pair of end plates is spaced apart from the stacked structure by a predetermined distance so as to define a fitting space into which a temperature sensor is fitted.

In one form of the present disclosure, each of the pair of end plates may include an inner plate, which is made of an insulation material and is in surface contact with the stacked structure, and an outer plate, which is disposed outside the inner plate so as to cover the inner plate and is more rigid than the inner plate.

In one form of the present disclosure, the outer plate of at least one of the pair of end plates may be shaped so as to be spaced apart from the stacked structure by a predetermined distance at one end thereof so as to define the fitting space into which a temperature sensor is fitted, and the inner plate of the at least one of the pair of end plates may have an exposure area corresponding to the fitting space so as to allow the stacked structure to be exposed through the exposing area.

In one form of the present disclosure, the outer plate may have therein a through hole, which is formed in an area thereof corresponding to the fitting space and into which an engagement hook provided on the temperature sensor is engaged.

In one form of the present disclosure, the battery module may further include a pair of bus bar assemblies, which are disposed at two ends of the stacked structure in a second direction perpendicular to the first direction so as to couple the plurality of battery cells, which are positioned at two ends of the stacked structure in the second direction, to each other, a first cover adapted to cover one surface of the stacked structure in a third direction perpendicular both to the first direction and to the second direction, a first clamp, which extends across the first cover from an outside of the first cover and is coupled at two ends thereof to the pair of end plates, a second clamp, which extends across a surface of the stacked structure opposite a surface of the stacked structure at which the first cover is disposed and is coupled at two ends thereof to the pair of end plates, and second and third covers, which are respectively disposed outside the pair of bus bar assemblies so as to cover the stacked structure in the second direction.

In one form of the present disclosure, the stacked structure may include a plurality of cell assemblies, each of which includes a pair of battery cells and a surface pressure pad interposed between the pair of battery cells in a stacked state, the plurality of cell assemblies being stacked one on another in the first direction.

In one form of the present disclosure, the battery cells of the plurality of cell assemblies may be stacked one on another such that electrodes thereof having the same polarity are disposed adjacent to each other.

In one form of the present disclosure, the plurality of cell assemblies of the stacked structure may be stacked one on another such that cell assemblies having different polarities are disposed adjacent to each other.

In one form of the present disclosure, the plurality of cell assemblies may be stacked with hot melt interposed therebetween.

In one form of the present disclosure, each of the pair of bus bar assemblies may include a bus bar having a plurality of slits, and the electrodes of the plurality of battery cells may extend through the slits, and the regions of the electrodes that project through the slits may be bent and coupled to the bus bars.

In one form of the present disclosure, the pair of bus bar assemblies may include a circuit constituting a cell management unit adapted to detect voltages of the battery cells.

In one form of the present disclosure, the first clamp may be attached to the first cover, and the two ends of the first clamp may be bent so as to face the pair of end plates, and may be coupled to outer surfaces of the end plates.

In one form of the present disclosure, the two ends of the second clamp may be bent so as to face the pair of end plates, and may be coupled to outer surfaces of the end plates.

In one form of the present disclosure, there is provided a battery pack including a plurality of battery modules, each of which includes a plurality of battery cells, which are stacked one on another in a first direction, and a pair of end plates, which are respectively in surface contact with two ends of the stacked structure, in which the plurality of battery cells are stacked, in the first direction, wherein at least one of the pair of end plates is spaced apart from the stacked structure by a predetermined distance so as to define a fitting space into which a temperature sensor is fitted, a lower case on which the plurality of battery modules are mounted, and a temperature sensor fitted into at least one of fitting spaces formed in the plurality of battery modules.

In one form of the present disclosure, each of the pair of end plates may include an inner plate, which is made of an insulation material and is in surface contact with the stacked structure, and an outer plate, which is disposed outside the inner plate so as to cover the inner plate and has a rigidity higher than a rigidity of the inner plate.

In one form of the present disclosure, the outer plate of at least one of the pair of end plates may be shaped so as to be spaced apart from the stacked structure by a predetermined distance at one end thereof so as to define the fitting space into which a temperature sensor is fitted, and the inner plate of the at least one of the pair of end plates may have an exposing area corresponding to the fitting space so as to allow the stacked structure to be exposed through the exposing area.

In one form of the present disclosure, the temperature sensor may include an engagement hook, which exerts elasticity toward the outer plate and has a wedge shape, width of which decreases moving in the direction in which the temperature sensor is fitted, and the outer plate may have therein a through hole, which is formed in a region corresponding to the fitting space and with which the engagement hook is engaged.

### DRAWINGS

The above and other objects, features and other advantages of the present disclosure will be more clearly understood from the following detailed description taken in conjunction with the accompanying drawings, in which:

FIG. 1 is a top perspective view of a battery module in some forms of the present disclosure;

FIG. 2 is a bottom perspective view of the battery module shown in FIG. 1;

FIG. 3 is an exploded perspective view of the battery module shown in FIG. 1;

FIG. 4 is a perspective view illustrating the structure of a cell assembly of the battery module in some forms of the present disclosure;

FIG. 5 is a perspective view illustrating the stacked structure of the battery module in some forms of the present disclosure;

FIG. 6 is a perspective view illustrating the positional relationship between the stacked structure and the end plates of the battery module in some forms of the present disclosure;

FIG. 7 is an enlarged plan view illustrating the outer and inner surfaces of one of the pair of end plates shown in FIG. 6;

FIG. 8 is an enlarged view specifically illustrating a fitting space formed in the outer plate shown in FIG. 7;

FIG. 9 is a perspective view illustrating the appearance of an exemplary temperature sensor fitted into the battery module in some forms of the present disclosure;

FIG. 10 is a cross-sectional view illustrating the battery module in some forms of the present disclosure in which the temperature sensor is mounted, which is broken away in the first direction, extending through the temperature sensor;

FIG. 11 is a perspective view illustrating the positional relationship between the stacked structure and the bus bar assemblies of the battery module in some forms of the present disclosure;

FIG. 12 is an enlarged plan view illustrating the bus bar assembly applied to the battery module in some forms of the present disclosure;

FIG. 13 is a plan view illustrating the state in which the bus bars of the bus bar assembly shown in FIG. 12 are coupled to the electrodes of the battery cells of the stacked structure;

FIG. 14 is an exploded perspective view illustrating the positional relationships between the cover, the first clamp and the second clamp of the battery module;

FIG. 15 is a view illustrating one end of the first clamp shown in FIG. 14;

FIG. 16 is a perspective view illustrating the positional relationships between the second cover, the third cover and the stacked structure of the battery module in some forms of the present disclosure;

FIG. 17 is a view specifically illustrating the battery module in some forms of the present disclosure to which the second and third covers are mounted;

FIG. 18 is a cross-sectional view illustrating a portion of the battery pack in some forms of the present disclosure to which the battery modules are mounted;

FIG. 19 is a plan view illustrating the battery pack in which the battery modules in some forms of the present disclosure are mounted;

FIG. 20 is a perspective view illustrating an example in which a temperature sensor is provided in the fitting space in the battery module in some forms of the present disclosure; and

FIG. 21 is a perspective view illustrating an example in which a dummy is provided in the fitting space in the battery module in some forms of the present disclosure.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

Hereinafter, a battery module and a battery pack including the same according to one of various embodiments of the present disclosure will be described in detail with reference to the accompanying drawings.

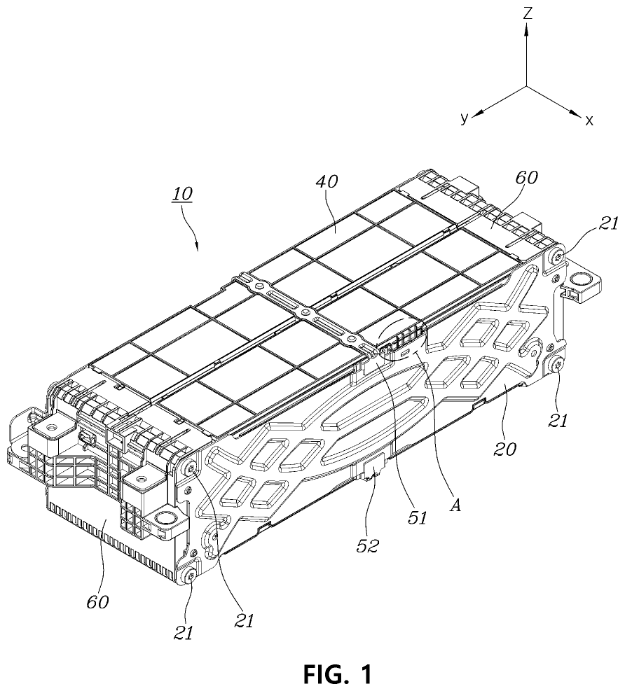

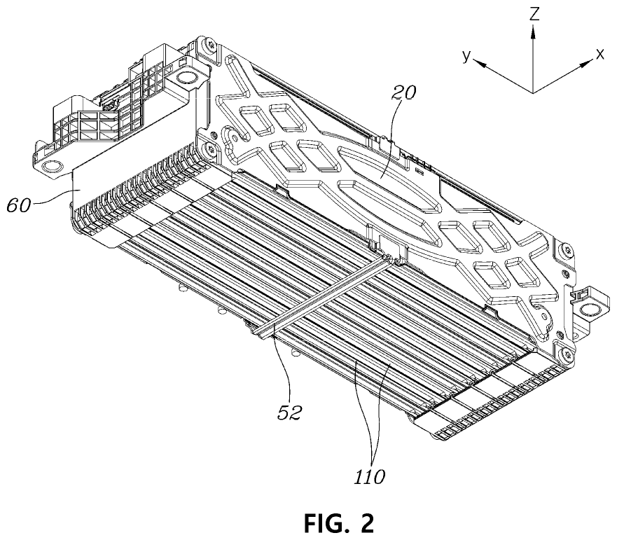

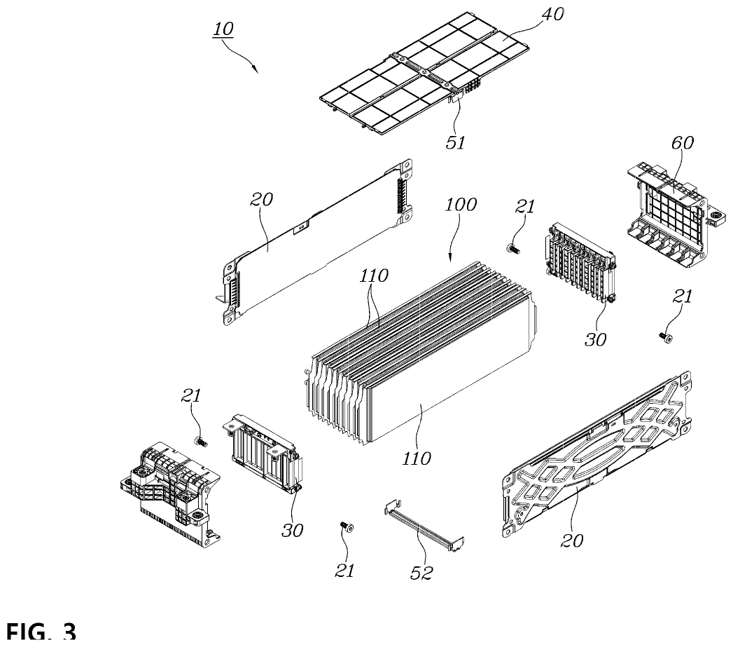

FIG. 1 is a top perspective view of a battery module according to an embodiment of the present disclosure. FIG. 2 is a bottom perspective view of the battery module shown in FIG. 1. FIG. 3 is an exploded perspective view of the battery module shown in FIG. 1.

Referring to FIGS. 1 to 3, the battery module 10 according to an embodiment of the present disclosure may include a plurality of battery cells 110, which are stacked one on another in a first direction (an x-axis direction), a pair of end plates 20, which are respectively attached in a surface-contact manner to the two ends of the stacked structure 100, in which the plurality of battery cells 110 are stacked, in the first direction, a pair of bus bar assemblies 30, which are disposed at the two ends of the stacked structure 100 in a second direction (a y-axis direction) perpendicular to the first direction and are coupled to the electrodes of the plurality of battery cells 110, a first cover 40 covering one surface of the stacked structure 100 in a third direction (a z-axis direction) perpendicular both to the first direction and to the second direction, a first clamp 51, which extends across the first cover 40 from the periphery of the first cover 40 and is coupled at the two ends thereof to the pair of end plates 20, and a second clamp 52, which extends across the surface of the stacked structure 100 that faces the surface of the stacked structure 100 on which the first cover 40 is disposed and is coupled at the two ends thereof to the pair of end plates 20.

Furthermore, the battery module according to an embodiment of the present disclosure may include second and third covers 60, which are positioned outside the bus bar assemblies 30 so as to cover the two ends of the stacked structure 100 in the second direction.

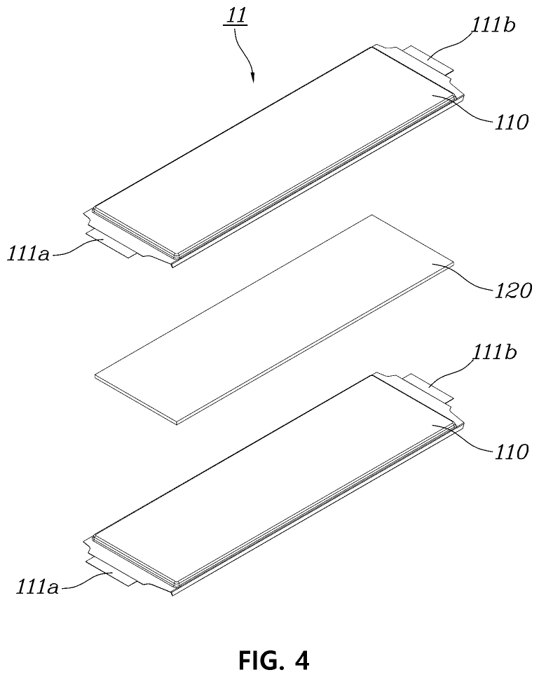

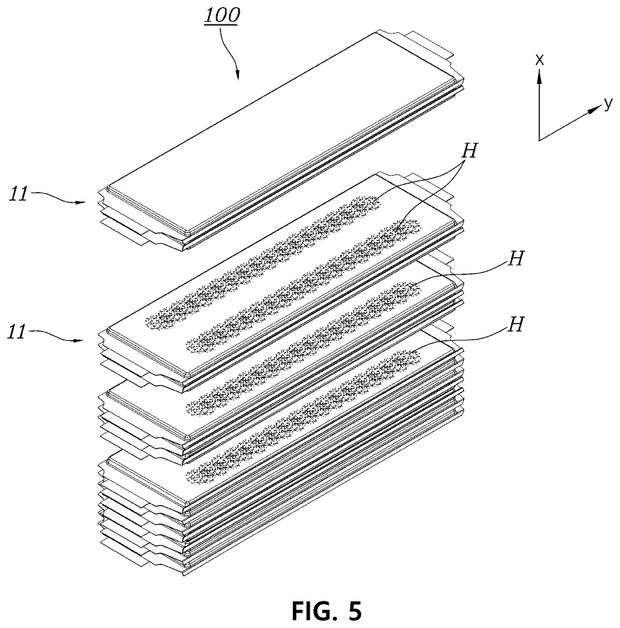

FIG. 4 is a perspective view illustrating the structure of a cell assembly 11 of the battery module according to an embodiment of the present disclosure. FIG. 5 is a perspective view illustrating the stacked structure 100 of the battery module according to an embodiment of the present disclosure.

As illustrated in FIG. 4, the stacked structure 100 in which the plurality of battery cells 110 are stacked one on another may include the cell assembly 11, including a pair of battery cells 110 and a surface-pressure pad 120 interposed between the pair of battery cells 110, which is prepared by sequentially layering one battery cell 110, the surface-pressure pad 120 and another battery cell 110. In other words, the stacked structure 100 may be manufactured by layering a plurality of cell assemblies 11, each of which is prepared as illustrated in FIG. 4, in the manner illustrated in FIG. 5.

In one cell assembly 11, the battery cells 110 may be oriented such that electrodes having the same polarity (for example, a positive electrode 111a or a negative electrode 111b) are positioned adjacent to each other.

The surface-pressure pad 120 is an element adapted to provide elasticity when the battery cells 110 are swollen, thereby preventing deformation of the battery module.

A plurality of cell assemblies 11 may be stacked one on another via a hot melt H. The hot melt H, which is a kind of liquid adhesive that provides adhesive force when heat is applied thereto, may be applied to the surfaces of the cell assemblies 11 in a predetermined pattern before the cell assemblies 11 are stacked one on another. After the plurality of cell assemblies 11 are stacked, the stacked cell assemblies 11 are aligned with each other and are then simultaneously subjected to heating, thereby realizing the desired positional relationship between the cell assemblies 110.

The cell assemblies 11 in the stacked structure 100 may be stacked one on another such that electrodes having different polarities are positioned adjacent to each other. The reason for this is to establish an electrical serial connection relationship between the cell assemblies 11 when the bus bars of the bus bar assembly 30 are connected to the electrodes of the battery cells. In other words, the battery cells 110 in the cell assembly 11 may be electrically connected to each other in series, and the cell assemblies 11 may also be electrically connected to each other in series.

Hereinafter, for brevity of explanation, the direction in which the battery cells 110 are layered one on another will be referred to as the first direction (an x-axis direction), and a direction that extends between the electrodes of one battery cell 110 and which is perpendicular to the first direction will be referred to as the second direction (a y-axis direction). Furthermore, a direction perpendicular both to the first direction and to the second direction, that is, a direction that extends between the sides of the battery cell 110 at which the electrodes are not formed, will be referred to as the third direction (a z-axis direction).

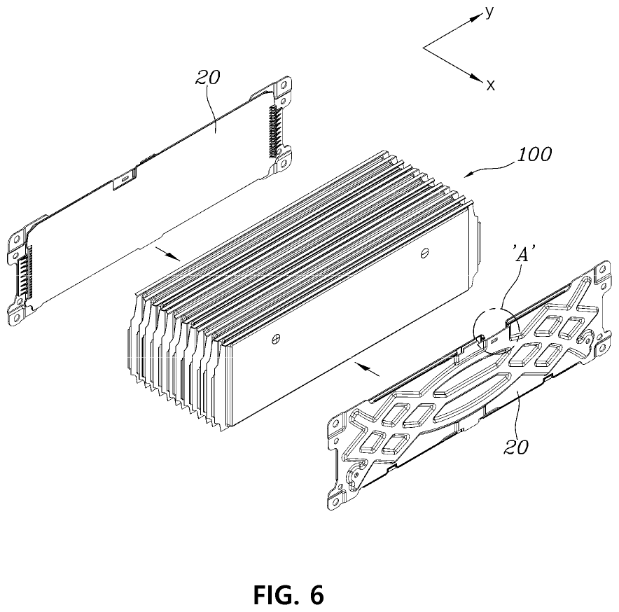

FIG. 6 is a perspective view illustrating the positional relationship between the stacked structure 100 and the end plates 20 of the battery module according to an embodiment of the present disclosure.

As illustrated in FIG. 6, the pair of end plates 20 may be disposed so as to be in surface contact with the surfaces of the two ends of the stacked structure 100 in the direction in which the battery cells 110 are stacked, that is, the exposed surfaces of the outermost ones among the battery cells 110 constituting the stacked structure 100.

The pair of end plates 20 are elements that serve to maintain the distance therebetween constant in order to prevent deformation of the battery module by virtue of the rigidity thereof and to maintain constant surface pressure between the stacked battery cells 110 when the battery cells 110 become swollen. Accordingly, the end plates 20 must have sufficient rigidity to prevent deformation of the battery module while maintaining the surface pressure between the battery cells 110, and may preferably include an additional means for making the surface pressure uniform.

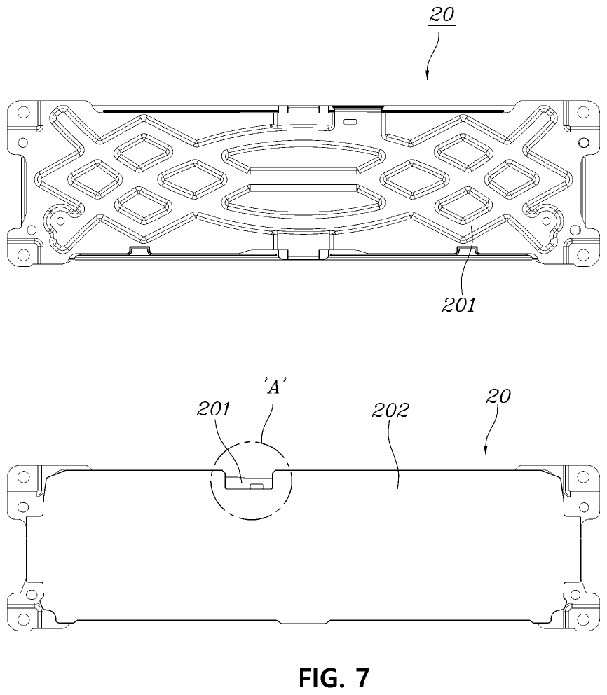

FIG. 7 is an enlarged plan view illustrating the outer and inner surfaces of one of the pair of end plates shown in FIG. 6.

As illustrated in FIG. 7, each of the pair of end plates 20 may include an outer plate 201, which is exposed outwards from the battery module 10, and an inner plate 202, which is covered by the outer plate 210 and is in surface contact with the stacked structure 100. The outer plate 201 may be embodied by metal, such as aluminum, which has sufficient rigidity and a light weight. The inner plate 202 may be embodied by an insulation material, such as plastic, which has rigidity lower than the outer plate 201 but is capable of ensuring electrical insulation when the inner plate 202 is in surface contact with the outermost battery cell 110 of the stacked structure 100.

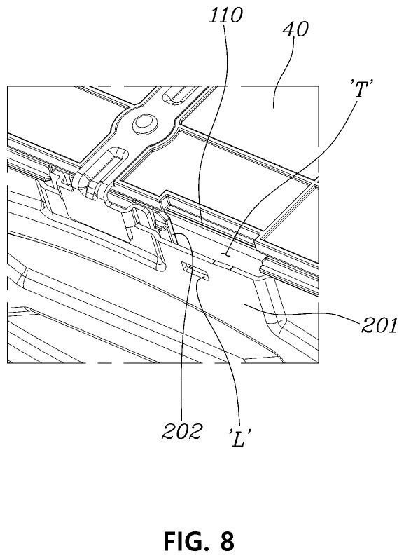

FIG. 8 is an enlarged view specifically illustrating a fitting space formed in the outer plate 201 shown in FIG. 7.

In an embodiment of the present disclosure, the side of the outer plate 210 of the end plate 20, which extends in the second direction, may have formed therein the fitting space T, which is formed by various metal-shaping technologies, so as to allow a temperature sensor to be fitted thereinto in the state of being spaced apart from the stacked structure 100 by a predetermined distance. The area in which the fitting space T is formed corresponds to the circle area A in FIG. 7, and FIG. 8 is an enlarged view illustrating the circle area A.

A plurality of battery modules 10 according to an embodiment of the present disclosure are disposed in a case, which is designed depending on the kind of vehicle, thereby embodying a single battery pack. For management of the battery pack, it is very important to monitor the internal temperature in the battery pack. A typical battery module is manufactured so as to have a built-in temperature sensor.

In contrast, the battery module according to an embodiment of the present disclosure may have formed therein the fitting space, in which a temperature sensor is fitted at the outside the battery module 10, without having to include the temperature sensor therein such that the temperature sensor can be disposed at a desired position at which detection of temperature is required after a plurality of battery modules are disposed in the case of the battery pack.

Specifically, the battery module 10 according to an embodiment of the present disclosure is constructed such that the surface of the battery module 10 opposite the surface of the battery module 10 that is covered by the first cover 40 is not provided with a covering component, thereby allowing the battery cells to be exposed to the outside. The battery module 10 is disposed in the case of the battery pack such that the surface of the battery module 10 through which the battery cells are exposed faces the bottom surface of the case. Accordingly, it is preferable that the fitting space T be formed in the end of the outer plate 201 adjacent to the first cover 40 such that a predetermined space is defined between the stacked structure 10 and the outer plate 201. The inner plate 202 may be partially cut out so as to define an open area such that the temperature sensor comes into contact with the battery cells 110 in the fitting space.

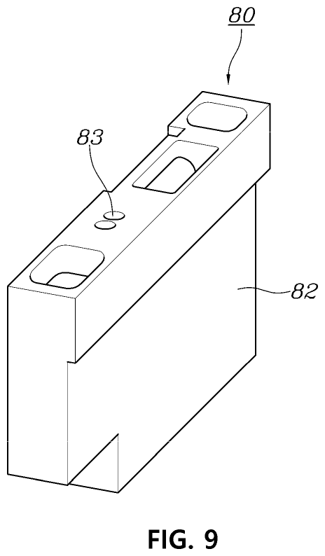

FIG. 9 is a perspective view illustrating the appearance of an exemplary temperature sensor fitted into the battery module according to an embodiment of the present disclosure.

As illustrated in FIG. 9, the temperature sensor may include a housing 82 having a size appropriate to be fitted into the fitting space T, a temperature-sensing element (not shown) provided in the housing 82, and a guide hole 83 adapted to guide an electrical wire for transmission of the output of the temperature-sensing element. Here, the temperature-sensing element may be an NTC (Negative Temperature Coefficient) thermistor the resistance value of which varies upon variation in temperature.

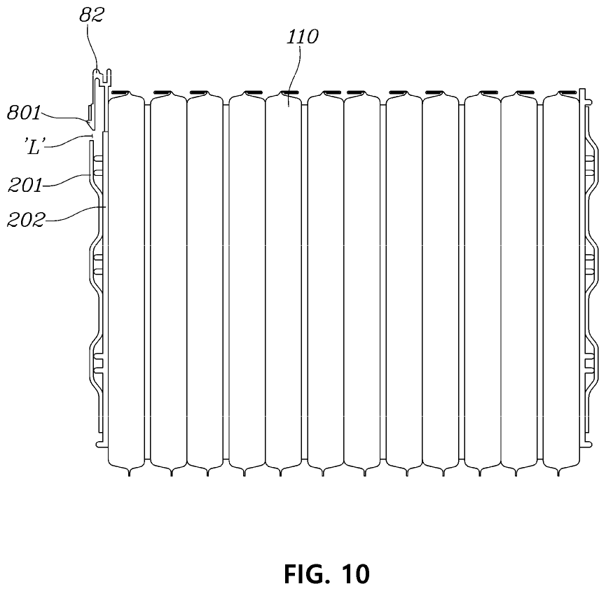

FIG. 10 is a cross-sectional view illustrating the battery module according to an embodiment of the present disclosure in which the temperature sensor is mounted, which is broken away in the first direction extending through the temperature sensor. In FIG. 10, the first cover 40 is removed from the battery module.

Referring to FIG. 10, the housing 82 of the temperature sensor 80 may include an engagement hook 801, which is formed at the surface thereof that comes into contact with the outer plate 201 so as to exert elastic force toward the outer plate 201 when the temperature sensor 80 is fitted into the fitting space T, and the outer plate 201 may have a through hole L, which is formed in the area of the outer plate 201 in which the fitting space T is formed and with which the engagement hook 801 is engaged. The engagement hook 801 may have a wedge shape, the width of which decreases moving in the direction in which the temperature sensor is fitted. Accordingly, when the engagement hook 801 passes over the through hole L, the engagement hook 801 may enter the through hole L and may be engaged with the edge of the through hole L, thereby establishing a locked structure.

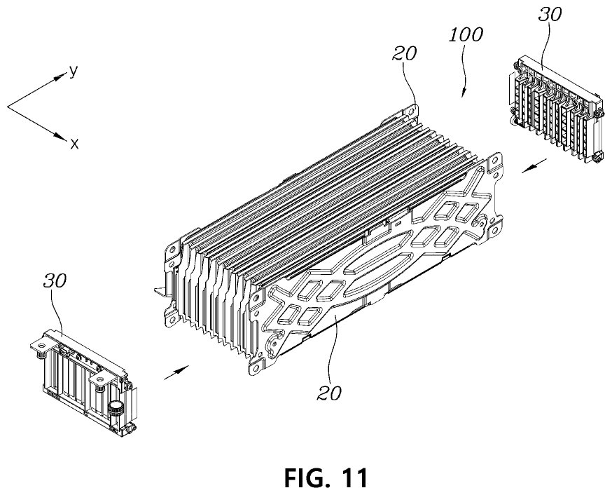

FIG. 11 is a perspective view illustrating the positional relationship between the stacked structure and the bus bar assemblies of the battery module according to an embodiment of the present disclosure.

As illustrated in FIG. 11, the bus bar assemblies 30 may be mounted on the two ends of the stacked structure 100 in the second direction, perpendicular to the direction in which the battery cells are stacked, that is, a direction extending between the electrodes 111a and 111b of the battery cell 11.

The bus bar assemblies 30 are elements adapted to form an electrical connection between the electrodes 111a and 111b of the battery cells 110 of the stacked structure 100.

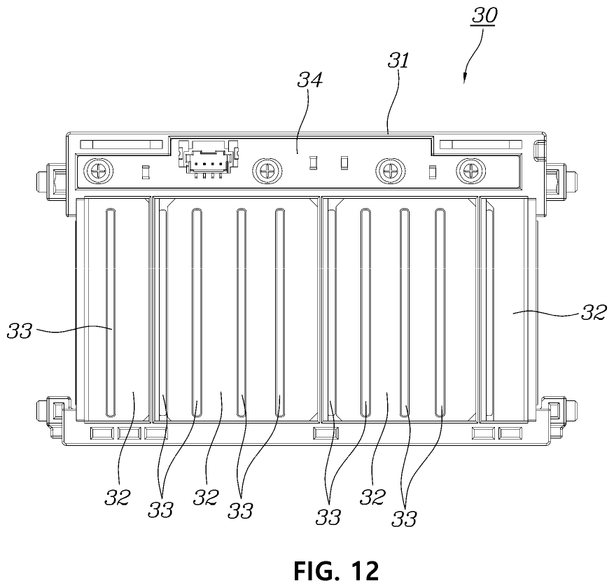

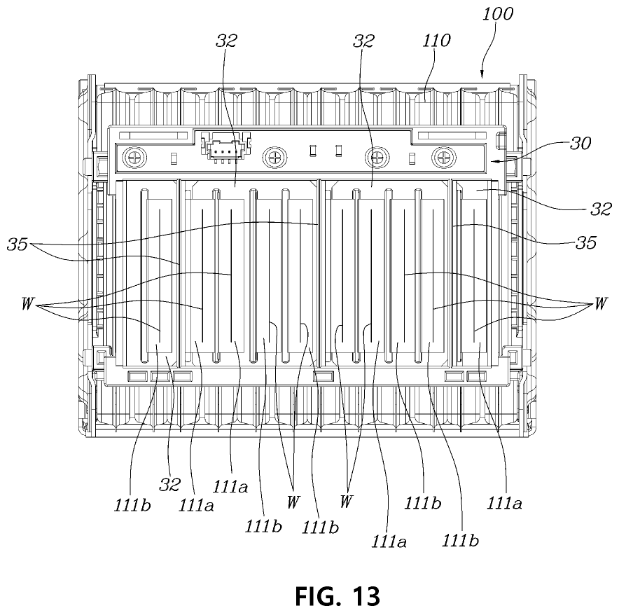

FIG. 12 is an enlarged plan view illustrating the bus bar assembly applied to the battery module according to an embodiment of the present disclosure. FIG. 13 is a plan view illustrating the state in which the bus bars of the bus bar assembly shown in FIG. 12 are coupled to the electrodes of the battery cells of the stacked structure.

As illustrated in FIG. 12, the bus bar assembly 30 may include a frame 31 made of an insulation material such as plastic, and bus bars 32, which are attached to the frame 31 and have slits 33 into which the electrodes 111a and 111b of the battery cells 110 are fitted. The distance between the slits 33 may correspond to the distance between the electrodes 111a and 111b of the battery cells 110. The frame 31 may include barrier walls 35, which are formed between bus bars 32 that are required to be electrically insulated from each other.

The bus bar assembly 30 may include a circuit 34 adapted to monitor the voltages of the battery cells 110 included in the battery module. The circuit 34 may be embodied as a structure which is composed of a circuit board, such as a PCB, and electric elements mounted on the circuit board.

As illustrated in FIG. 13, when the electrodes 111a and 111b of the battery cells 110 are fitted into the slits 33 formed in the bus bars 32 of the bus bar assembly 30, all of the electrodes 111a and 111b of the battery cells 110 may be bent simultaneously so as to come into contact with the bus bars 32, and may be coupled to the bus bars 32 through a welding process. In FIG. 13, reference numeral “W” denotes areas to which welding energy is applied.

A conventional battery module is manufactured in a manner such that a plurality of unit battery cells are first bent, and then subjected to first welding followed by second welding, thereby realizing electrical connection of the stacked structure of the battery cells. Because the conventional battery module is subjected to a plurality of bending and welding processes and it is difficult to ensure uniformity of the processes, there a problem in which a stepped portion or the like may be formed at a welding object in the second welding process.

In contrast, since an embodiment of the present disclosure adopts the bus bar assembly 30 in order to establish the electrical connection between all of the battery cells of the battery module through a single bending process and a single welding process, as illustrated in FIG. 11, it is possible to simplify the manufacturing process and to improve manufacturing quality.

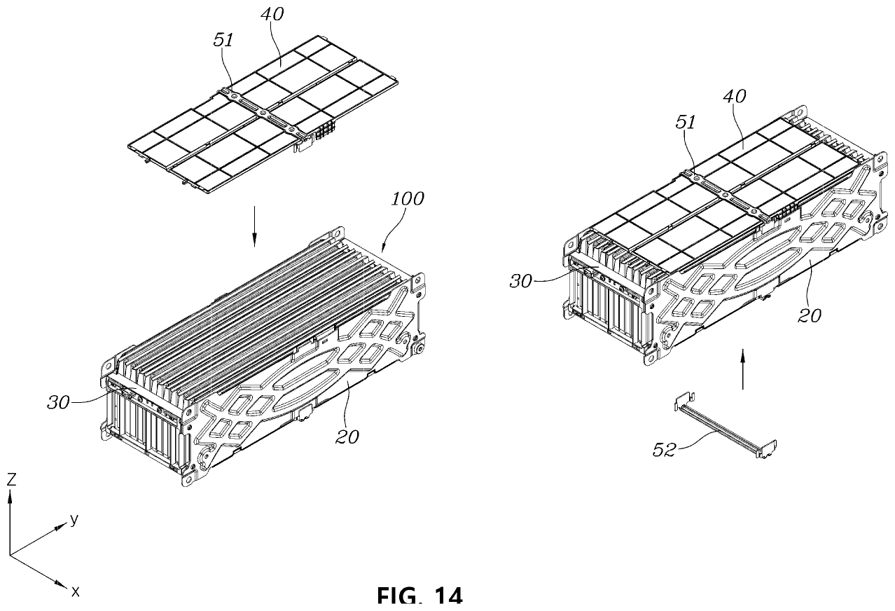

FIG. 14 is an exploded perspective view illustrating the positional relationships between the cover, the first clamp and the second clamp of the battery module.

As illustrated in FIG. 14, the first cover 40 may be disposed at one end of the stacked structure 100 in the third direction.

The first clamp 51, which extends across the first cover 40 from the outside of the first cover 40 in the first direction, may be disposed across the stacked structure 100, and may be coupled at the two ends thereof to the pair of end plates 20, respectively.

The second clamp 52, which extends in the first direction, may be disposed across the surface of the stacked structure 100 opposite the surface of the stacked structure 100 at which the first cover 40 is disposed, and may be coupled at the two ends thereof to the pair of end plates 20, respectively.

Since the first clamp 51 is fixed to the first cover 40 through thermal fusion bonding or the like and the two ends of the first clamp 51 are respectively coupled to the pair of end plates 20, it is possible to maintain the distance between the pair of end plates 20 even when the battery cells 110 become swollen. Furthermore, since the second clamp 52 is disposed close to the exposed surface (the lower surface in the drawing) of the stacked structure 100 in the state of being spaced apart from the exposed surface, it is also possible to maintain the distance between the pair of end plates 20 even when the battery cells 110 are swollen.

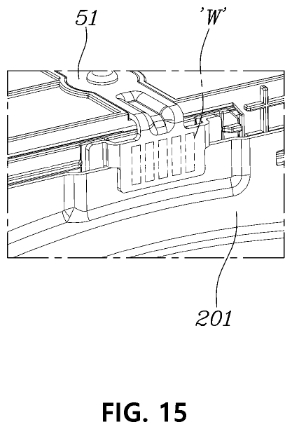

FIG. 15 is a view illustrating one end of the first clamp shown in FIG. 14.

As illustrated in FIG. 15, the first clamp 51 may have the shape of a hoe blade, which is bent toward the end plate 20, and the bent end of the first clamp 51 may face the outer surface of the end plate 20. The bent end of the first clamp 51 may be welded to an area W (welding area) of the outer surface near one side of the end plate 20, thereby being fixed to the end plate 20. The coupling structure illustrated in FIG. 11 may also be applied to the second clamp 52.

As described above, since the first clamp 51 is coupled to first sides (the upper sides in the drawing) of the pair of end plates 20 and the second clamp 52 is coupled to the second sides (the lower sides in the drawing) of the pair of end plates 20 to which the first clamp 51 is coupled, it is possible to maintain the distance between the pair of end plates at the center of the end plates in the second direction and it is thereby possible to apply the rigidity of the end plates to the internal battery cells.

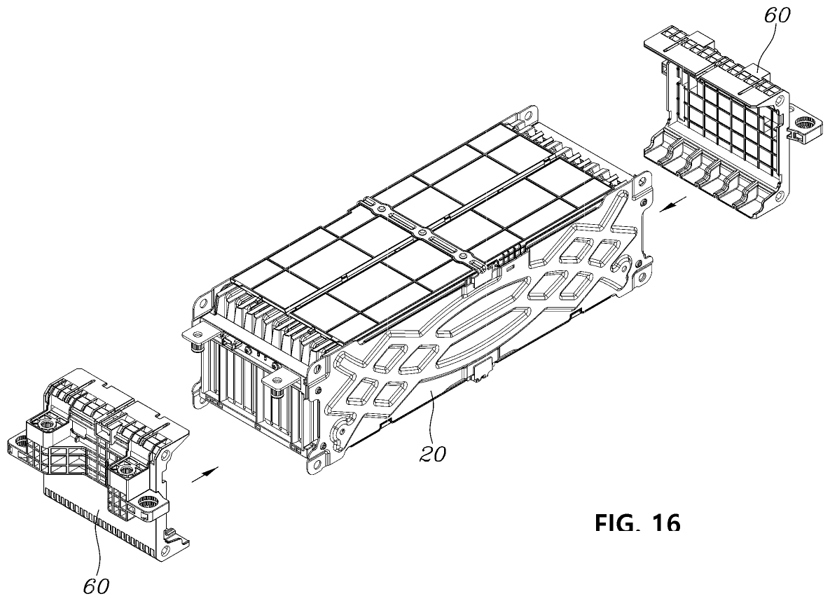

FIG. 16 is a perspective view illustrating the positional relationships between the second cover, the third cover and the stacked structure of the battery module according to an embodiment of the present disclosure.

As illustrated in FIG. 16, the second and third covers 60 may be respectively disposed at the two ends of the stacked structure 100 in the second direction, perpendicular to the direction in which the battery cells of the stacked structure 100 are stacked, that is, in the direction that extends between the electrodes 110a and 111b of the battery cell 110. Here, because the second and third covers 60 have substantially the same construction, and are mounted at symmetrical positions of the battery module 10, the second and third covers 60 are both denoted by the same reference numeral.

By mounting the second and third covers 60 to the stacked structure, the bus bar assemblies 30 may be covered by the second and third covers 60, and the battery module 10 may be completed. The second and third covers 60 may have through holes through which elements required to be exposed to the outside from the battery module among the elements of the bus bar assemblies 30 (for example, portions of the bus bars required to be exposed for external electrical connection, connectors for detection of cell voltage and the like) are exposed.

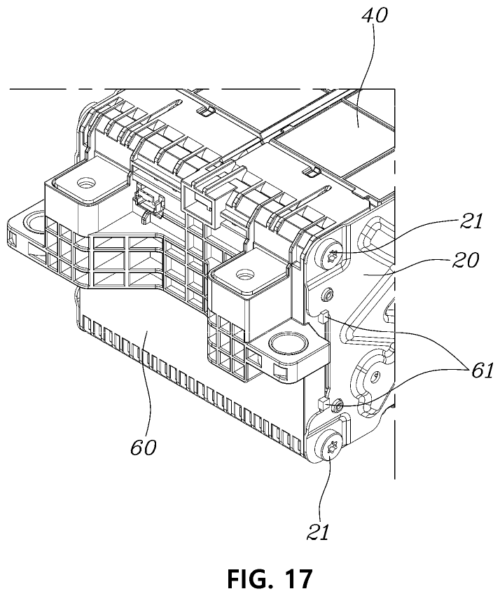

FIG. 17 is a view specifically illustrating the battery module according to an embodiment of the present disclosure to which the second and third covers are mounted.

As illustrated in FIG. 17, the lateral side surfaces of the second and third covers 30 may be in contact with the pair of end plates 20. The pair of end plates 20 and the lateral side surfaces of the second and third covers 30 may be coupled to each other via bolts 21. Although not illustrated in the drawings, the pair of end plates 20 may be coupled to the second and third covers 30 by engaging the bolts with the two ends of a single elongate nut disposed in the second and third covers 60.

Furthermore, the lateral side surfaces of the second and third covers 30 may be provided with engagement protrusions 61, which project in the first direction, and the edges of the end plates 20 may be engaged with the engagement protrusions 61, thereby assembling the second and third covers 30 with the end plates 20.

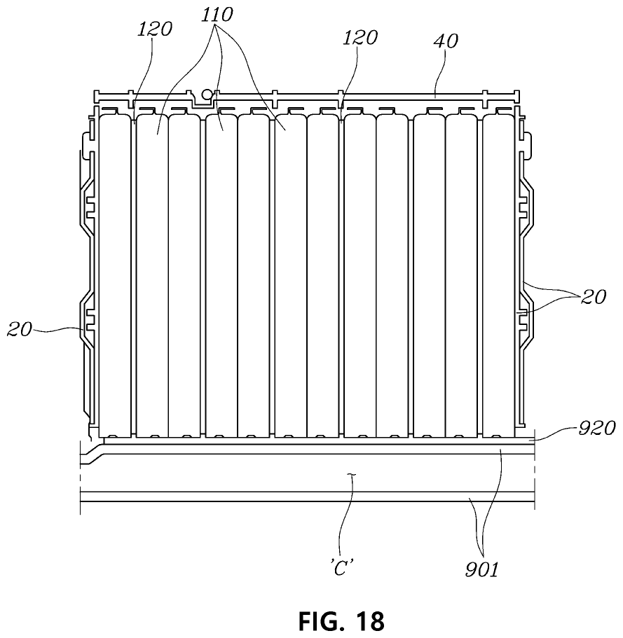

FIG. 18 is a cross-sectional view illustrating a portion of the battery pack according to an embodiment of the present disclosure to which the battery modules are mounted.

As illustrated in FIG. 18, the battery module 10 according to an embodiment of the present disclosure may be mounted in the lower case 910 of the battery pack. Generally, the bottom surface of the battery pack case 910 may serve as a mounting surface to which the battery module 10 is mounted.

As described above, the battery module 10 according to an embodiment of the present disclosure may be constructed such that one surface of the battery module 10 in the third direction is not covered by the cover and the battery cells 110 are thus exposed. The battery module 10 may be mounted in the battery pack such that the exposed surfaces of the battery cells 110 face the mounting surface of the battery pack case. When the battery module is mounted, a gap filler 920 may be interposed between the mounting surface of the battery pack case 910 and the exposed surface of the battery module such that the battery cells 110 are in indirect contact with the mounting surface of the battery pack case 910.

Here, the gap filler 920 may be made of a thermal interface material capable of transmitting the heat generated from the battery cells 110 to the battery pack case 910. Since the battery cells 110 are in contact with the mounting surface (the bottom surface) of the battery pack case 910 via the gap filler 920, without an additional interfering element therebetween, the heat generated by the battery cells 110 may be more easily discharged.

The region of the battery pack case 910 under the mounting surface to which the battery module 10 is mounted may be provided therein with a cooling channel C through which cooling water flows, thereby further improving effect of discharging heat.

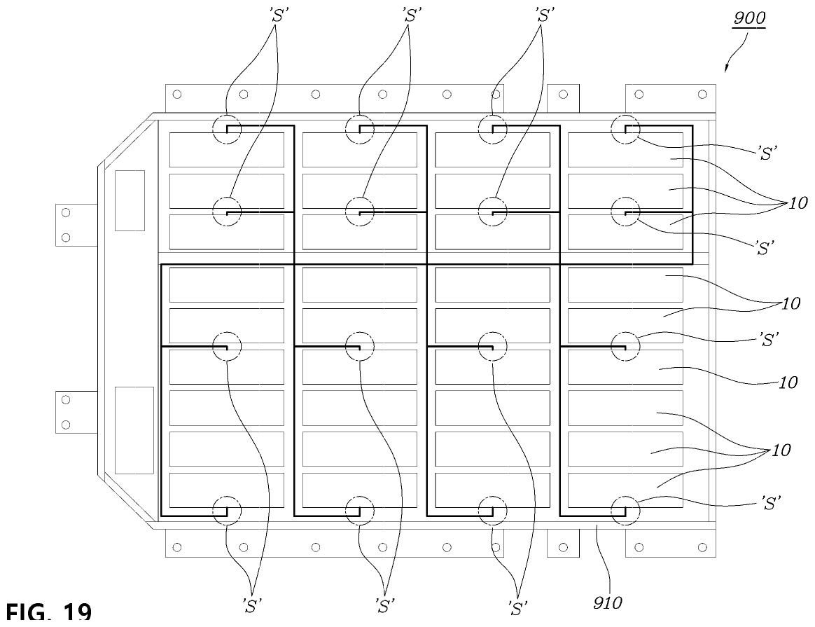

FIG. 19 is a plan view illustrating the battery pack in which the battery modules according to an embodiment of the present disclosure are mounted.

As illustrated in FIG. 19, the battery modules 10 according to an embodiment of the present disclosure may be mounted on the lower case 910 of the battery pack 900 in a predetermined pattern. Since each of the battery modules 10 according to an embodiment of the present disclosure has formed therein the fitting space T, into which a temperature sensor is fitted from the outside, the battery modules 10 may be mounted on the lower case 910 of the battery pack 900 in a desired pattern, and an appropriate number of temperature sensors may then be mounted at desired positions. In FIG. 19, reference numeral ‘S’ denotes the position at which the temperature sensor is mounted.

The battery pack 900, which includes the battery modules 10 according to an embodiment of the present disclosure, enables the number of temperature sensors, which are capable of being mounted therein, to be increased so as to increase accuracy of temperature detection, and enables the temperature sensors to be mounted at positions that are most suitable for battery control for the purpose of more efficient management of the battery. In other words, unlike the conventional technology, in which all battery modules are provided therein with temperature sensors, the battery module 10 according to one of the various embodiments of the present disclosure enables a desired number of temperature sensors to be mounted at desired positions, thereby improving efficiency in the design of a battery system and preventing an excessive number of temperature sensors from being mounted, thereby contributing to reduction of manufacturing costs by virtue of omission of temperature sensors.

The temperature sensor fitted into the battery module 10 may transmit temperature information to a cell management unit (CMU) provided in the battery pack via electrical wiring.

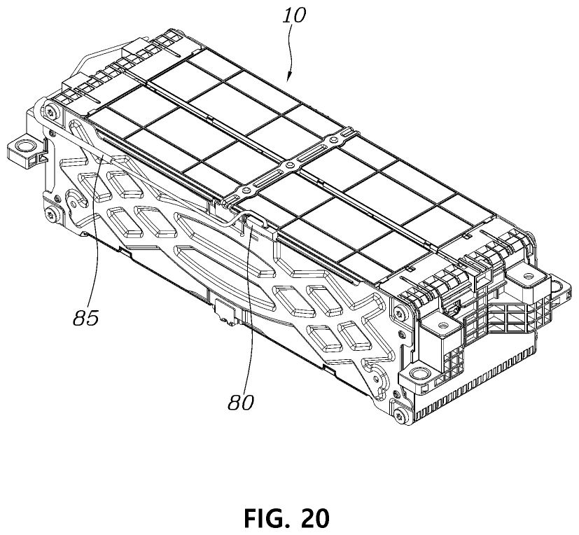

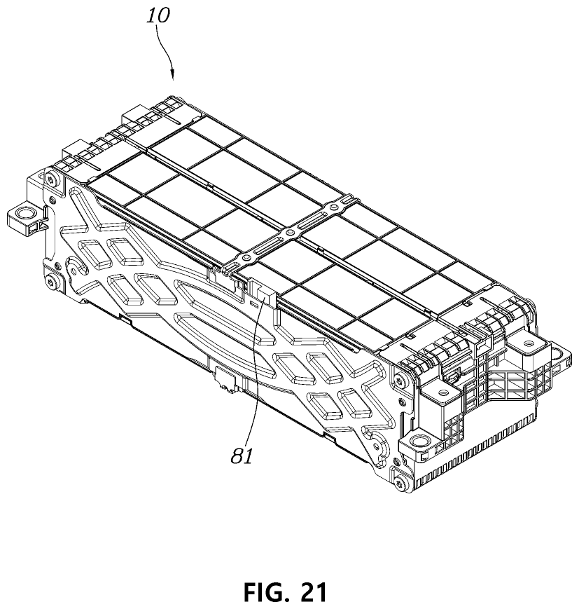

FIG. 20 is a perspective view illustrating an example in which a temperature sensor is provided in the fitting space in the battery module according to an embodiment of the present disclosure. FIG. 21 is a perspective view illustrating an example in which a dummy is provided in the fitting space in the battery module according to an embodiment of the present disclosure.

As illustrated in FIG. 20, when the temperature sensor 80 is fitted into the battery module 10, an electrical wire 35 may extends outwards from the temperature sensor 80, thereby transmitting the temperature information, detected by the temperature sensor 80 to a controller outside the battery module 10.

In this case, the battery cells 100 in the battery module, which are to be brought into contact with the temperature sensor 80, are exposed through the fitting space T, into which the temperature sensor 80 is to be fitted. Hence, the fitting spaces in which the temperature sensors 80 are not fitted may be provided therein with the dummies 81, each of which has an appearance similar to the temperature sensor 80 but does not have a sensor element or a guide hole 83, thereby preventing the battery cells 100 from being exposed to the outside through the fitting space T, as illustrated in FIG. 21.

As is apparent from the above description, the battery module and the battery pack including the same according to one of the various embodiments of the present disclosure are constructed such that the clamp is disposed at the center of the battery module in the direction in which the battery cells are stacked and is welded to the pair of end plates, and the pair of end plates are coupled to the covers at the two ends of the battery module through bolting, thereby ensuring sufficient rigidity.

Furthermore, since the battery module and the battery pack including the same according to one of the various embodiments of the present disclosure are constructed such that the electrodes of the plurality of battery cells are electrically connected to each other through a single bending process and a single welding process by adopting the bus bar assemblies, it is possible to simplify the manufacturing process and to improve quality of manufacture as a result of elimination of deviation between the battery cells.

In addition, the battery module and the battery pack including the same according to one of the various embodiments of the present disclosure are constructed such that the battery cells, which constitute the battery pack, are manufactured in a modular form. Accordingly, since it is possible to apply standardized battery cells to various kinds of battery packs even when the battery packs have different specifications depending on the kind of vehicle, it is possible to omit an additional design procedure for disposition of the battery cells in the battery pack and thus to reduce the period and cost of development.

Furthermore, since the battery module and the battery pack including the same according to one of the various embodiments of the present disclosure are constructed such that the battery cells in the battery module are in contact with the mounting surface of the battery pack case via the gap filler, without an additional interfering element, it is possible to more efficiently discharge the heat generated in the battery cells.

In addition, since the battery module and the battery pack including the same according to one of the various embodiments of the present disclosure are constructed such that temperature sensors for detecting the temperatures of the battery cells are not mounted in advance in the battery module but are fitted into the battery module from the outside, it is possible to reduce the cost incurred by mounting unnecessary temperature sensors. Furthermore, since it is possible to selectively mount the temperature sensors in temperature-sensing areas that have a great influence on the actual control of the battery, it is possible to improve the efficiency of the battery control. In addition, since the dummies are fitted into the fitting spaces in the battery module that do not need to be provided therein with temperature sensors, it is possible to make the battery cells in the battery modules safer.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A battery module comprising:
a plurality of battery cells, which are stacked in a first direction; and
a pair of end plates in contact with two ends of a stacked structure, in which the plurality of battery cells are stacked in the first direction,
wherein at least one end plate of the pair of end plates is spaced apart from the stacked structure by a predetermined distance to define a fitting space into which a temperature sensor is fitted.

2. The battery module according to claim 1, wherein each plate includes:
an inner plate made of an insulation material and is in contact with the stacked structure; and
an outer plate disposed outside of the inner plate to cover the inner plate and a rigidity of the outer plate is greater than a rigidity of the inner plate.

3. The battery module according to claim 2, wherein:
the outer plate spaced apart from the stacked structure by a predetermined distance at one end of the outer plate to define the fitting space into which a temperature sensor is fitted, and
the inner plate has an exposing area corresponding to the fitting space to allow the stacked structure to be exposed through the exposing area.

4. The battery module according to claim 2, wherein the outer plate includes:
a through hole formed in an area corresponding to the fitting space and into which an engagement hook provided on the temperature sensor is engaged.

5. The battery module according to claim 1, further comprising:
a pair of bus bar assemblies disposed at two ends of the stacked structure in a second direction perpendicular to the first direction to couple the plurality of battery cells to the pair of bus bar assemblies;
a first cover configured to cover one surface of the stacked structure in a third direction perpendicular both to the first direction and to the second direction;
a first clamp configured to extend across the first cover from an outside of the first cover and is coupled at two ends of the first clamp to the pair of end plates;
a second clamp configured to extend across a surface of the stacked structure opposite of a surface of the stacked structure at which the first cover is disposed and is coupled at two ends of the first clamp to the pair of end plates; and
a second and third covers, which are respectively disposed outside the pair of bus bar assemblies to cover the stacked structure in the second direction.

6. The battery module according to claim 1, wherein the stacked structure includes:
a plurality of cell assemblies, wherein each cell assembly includes a pair of battery cells and a surface pressure pad interposed between the pair of battery cells in a stacked state.

7. The battery module according to claim 6, wherein the battery cells are stacked such that electrodes of the battery cells having the same polarity are disposed adjacent to the battery cells.

8. The battery module according to claim 6, wherein the plurality of cell assemblies is stacked such that cell assemblies having different polarities are disposed adjacent to the cell assemblies.

9. The battery module according to claim 6, wherein the plurality of cell assemblies is stacked with hot melt interposed between the plurality of cell assemblies.

10. The battery module according to claim 5, wherein each bus bar assembly includes:
a bus bar having a plurality of slits, wherein the electrodes of the plurality of battery cells extend through the slits, and regions of the electrodes that project through the slits are bent and coupled to the bus bars.

11. The battery module according to claim 5, wherein the pair of bus bar assemblies includes:
a circuit comprising a cell management unit configured to detect voltages of the battery cells.

12. The battery module according to claim 5, wherein:
the first clamp is attached to the first cover, and
the two ends of the first clamp are bent to face the pair of end plates and are coupled to outer surfaces of the end plates.

13. The battery module according to claim 5, wherein:
the two ends of the second clamp are bent to face the pair of end plates, and are coupled to outer surfaces of the end plates.

14. A battery pack comprising:
a plurality of battery modules, wherein each battery module includes a plurality of battery cells stacked in a first direction;
a pair of end plates in surface contact with two ends of a stacked structure, in which the plurality of battery cells are stacked in the first direction, wherein at least one end plate is spaced apart from the stacked structure by a predetermined distance;
a lower case on which the plurality of battery modules is mounted; and
a temperature sensor fitted into a fitting space formed in the plurality of battery modules.

15. The battery pack according to claim 14, wherein each end plate comprises:
an inner plate made of an insulation material and is in surface contact with the stacked structure; and
an outer plate disposed outside of the inner plate to cover the inner plate and has a rigidity greater than a rigidity of the inner plate.

16. The battery pack according to claim 15, wherein:
the outer plate is spaced apart from the stacked structure by a predetermined distance at one end of the outer plate, and
the inner plate has an exposing area corresponding to the fitting space to allow the stacked structure to be exposed through the exposing area.

17. The battery pack according to claim 15, wherein the temperature sensor includes:
an engagement hook configured to exert elasticity toward the outer plate and has a wedge shape, wherein a width of the engagement hook decreases moving in a direction in which the temperature sensor is fitted, and
wherein the outer plate has a through hole formed in a region corresponding to the fitting space and the engagement hook is engaged with the through hole.
